(19) United States
(12) Patent Application Publication
(10) Pub. No.: US 2026/0208812 A1
(43) Pub. Date: Jul. 23, 2026

(54) IMAGE PROCESSING SYSTEM

(71) Applicant: KABUSHIKI KAISHA TOKAI-RIKA-DENKI-SEISAKUSHO, Niwa-gun, Aichi (JP)

(72) Inventors: Tomonori ICHIKAWA, Niwa-gun, Aichi (JP); Furuna YAMAMOTO, Niwa-gun, Aichi (JP); Toshinari NAKAI, Niwa-gun, Aichi (JP)

(21) Appl. No.: 19/142,562

(22) PCT Filed: Dec. 11, 2023
(86) PCT No.: PCT/JP2023/044317

§ 371 Date: Jun. 23, 2025

(30) Foreign Application Priority Data
Dec. 23, 2022 (JP) 2022-207657

(51) Int. Cl. B62J 50/22; B60R 1/26; B62J 45/20; B62J 45/41; G01S 13/42; G01S 13/86; H04N 5/77; H04N 7/18; H04N 23/90

(52) U.S. Cl. CPC B62J 50/22; B60R 1/26; B62J 45/20; B62J 45/41; G01S 13/42; G01S 13/867; H04N 7/181; H04N 23/90; B60R 2300/105; B60R 2300/70

(57) ABSTRACT

A image processing system includes an imaging device that images an area behind a motorcycle; a display device that is disposed to be located in front of a rider and displays an image based on image data acquired from the imaging device, and a control device is configured to perform first control of storing, in a storage device, first image data of a first image corresponding to a first region in an imaging range of a captured image captured by the imaging device during traveling of the motorcycle, and second control of displaying, on the display device, a second image corresponding to a second region narrower than the first region in the imaging range.

### TECHNICAL FIELD

The present disclosure relates to an image processing system.

### BACKGROUND ART

Conventionally, there is known a technique of displaying a rear view image obtained by imaging an area behind a two-wheeled vehicle on a display device and providing visual information regarding the area behind the two-wheeled vehicle to a rider. For example, Japanese Patent Application Laid-Open (JP-A) No. 2013-60128 discloses a rear view image display device that displays a partial region of an image obtained by imaging an area behind a two-wheeled vehicle on a display device.

Japanese Utility Model Registration No. 3227672 suggests that such a rear image display device and a recorder can cooperate with each other. Japanese Patent Application Laid-Open (JP-A) No. 2008-225976 discloses an operation status storage device that stores image data obtained by imaging an area behind a two-wheeled vehicle in volatile sub-storage means such as an SDRAM, and stores only image data at a time at which longitudinal acceleration exceeds a threshold among the pieces of image data stored in the sub-storage means in nonvolatile storage means such as a flash memory.

### SUMMARY OF INVENTION

### Technical Problem

Generally, an electronic control unit (ECU) attached to a vehicle is provided for each control target. For example, in a case in which an image displayed on a display device is stored, it is conceivable that a display control ECU that performs control to display an image on a display device and a storage control ECU that performs control to store image data in a storage device are disposed in a vehicle.

However, in the case of a motorcycle such as a two-wheeled vehicle and a three-wheeled vehicle, an installation space of ECUs is limited compared with a vehicle, and thus a large number of ECUs cannot be disposed. In order to increase the number of ECUs to be disposed, various design changes are required.

A range of an image that a rider wants to see while traveling may be different from a range of an image that the rider wants to see as verification in a case in which an accident occurs, for example. In the case of verification, it is desirable to check the surroundings of the vehicle in the widest possible range.

An object of the present disclosure is to provide an image processing system capable of displaying an image suitable for rear checking on a display device without adding a control device and storing an image covering a wider range than an image to be displayed in a storage device. The “image” in the present disclosure includes a video and a still image.

### Solution to Problem

A image processing system of a first aspect of the present disclosure includes an imaging device that images an area behind a motorcycle; a display device that is disposed to be located in front of a rider and displays an image based on image data acquired from the imaging device; and a control device that is configured to perform first control of storing, in a storage device, first image data of a first image corresponding to a first region in an imaging range of a captured image captured by the imaging device during traveling of the motorcycle, and second control of displaying, on the display device, a second image corresponding to a second region that is narrower than the first region in the imaging range.

In the image processing system of the first aspect of the present disclosure, the image processing system of a second aspect of the present disclosure, the control device is configured to perform the second control of displaying the second image on the display device at a timing that is different from a timing of the first control of storing the first image data in the storage device.

In the image processing system of the first aspect or the second aspect of the present disclosure, the image processing system of a third aspect of the present disclosure further includes at least one second imaging device that images an area in front of or on a side of the motorcycle, in which in the first control, the control device is configured to store, in the storage device, second image data acquired from the at least one second imaging device at a time when the first image is acquired, in association with the first image data.

According to the image processing system of a fourth aspect of the present disclosure, in the image processing system of the third aspect of the present disclosure, the control device is configured to further perform third control of reproducing the first image data stored in the storage device and displaying an image on the display device, and the third control includes displaying an image that is different from the first image on the display device based on combined image data obtained by combining the first image data and the second image data stored in the storage device.

According to the image processing system of a fifth aspect of the present disclosure, in the image processing system of any one of the first to fourth aspects of the present disclosure, the control device is configured to perform a fourth control that causes the display device to display an image of a range that is different from that of the second image in response to an image switching instruction received from the rider during display of the second image.

According to the image processing system of a sixth aspect of the present disclosure, in the image processing system of any one of the first to fifth aspects of the present disclosure, at least one of the first image data or image data of the second image is subjected to predetermined image processing including rotation correction.

In the image processing system according to any one of the first to sixth aspects of the present disclosure, the image processing system of a seventh aspect of the present disclosure further includes a microphone that collects sound, wherein in the first control, the control device is configured to store, in the storage device, audio data acquired from the microphone at a time when the first image is acquired, in association with the first image data.

In the image processing system of any one of the first to seventh aspects of the present disclosure, the image processing system of an eighth aspect of the present disclosure further includes a sensor that detects a distance and a direction from an obstacle around the motorcycle, in which in the first control, the control device is configured to store, in the storage device, detection data acquired from the sensor at a time when the first image is acquired, in association with the first image data.

According to the image processing system of a ninth aspect of the present disclosure, in the image processing system according to any one of the first to eighth aspects of the present disclosure, the storage device is disposed inside a vehicle body of the motorcycle together with the control device.

According to the image processing system according to a tenth aspect of the present disclosure, in the image processing system of the ninth aspect of the present disclosure, the storage device is a portable recording medium.

According to the image processing system of an eleventh aspect of the present disclosure, in the image processing system according to any one of the first to eighth aspects of the present disclosure, the storage device is disposed outside a vehicle body of the motorcycle, and the control device is configured to transmit the first image data to the external storage device and cause the external storage device to store the first image data.

According to the image processing system of a twelfth aspect of the present disclosure, in the image processing system according to any one of the first to eleventh aspects of the present disclosure, the first image data is image data that is acquired from the imaging device and is not subjected to any processing.

### Advantageous Effects of Invention

According to the image processing system of the first aspect of the present disclosure, it is possible to display an image suitable for rear checking on the display device without adding a control device, and store an image in a wider range than the image to be displayed in the storage device.

According to the image processing system of the second aspect of the present disclosure, an image can be displayed on the display device at an appropriate timing.

According to the image processing system of the third aspect of the present disclosure, a larger amount of information than information from one piece of image data can be obtained from a plurality of pieces of image data captured at the same time.

According to the image processing system of the fourth aspect of the present disclosure, the stored image data can be reproduced in various display modes, and a situation around the vehicle can be verified from different angles.

According to the image processing system of the fifth aspect of the present disclosure, it is possible to display the second image in a wider range than the first image to the rider even during traveling.

According to the image processing system of the sixth aspect of the present disclosure, the image data after the image processing can be displayed and stored.

According to the image processing system of the seventh aspect of the present disclosure, it is possible to obtain a larger amount of information from the audio data and the image data acquired at the same time than information from only image data.

According to the image processing system of the eighth aspect of the present disclosure, it is possible to obtain a larger amount of information from the detection data of the sensor and the image data acquired at the same time than information from only the image data.

According to the image processing systems of the ninth aspect and the tenth aspect of the present disclosure, it is possible to prevent theft of the storage device in which the image data is stored. In particular, this is effective in a case in which the storage device is a portable storage medium.

According to the image processing system of the eleventh aspect of the present disclosure, image data can be safely stored in an external storage device.

According to the image processing system of the twelfth aspect of the present disclosure, it is possible to store image data including a larger amount of visual information than in a case in which image data after image processing is stored.

### BRIEF DESCRIPTION OF DRAWINGS

FIG. 1 is a schematic diagram illustrating an example of a configuration of an image processing system according to a first embodiment of the present disclosure.

FIG. 2A is a schematic diagram illustrating another example of arrangement of an imaging device.

FIG. 2B is a schematic diagram illustrating still another example of arrangement of the imaging device.

FIG. 3 is a schematic diagram illustrating an example of arrangement of a display device.

FIG. 4 is a block diagram illustrating an example of an electrical configuration of the image processing system according to the first embodiment of the present disclosure.

FIG. 5 is a functional block diagram illustrating an example of a functional configuration of a control device according to the first embodiment of the present disclosure.

FIG. 6A is a flowchart illustrating an example of a flow of a process of an image storage/display program according to the first embodiment of the present disclosure.

FIG. 6B is a flowchart illustrating an example of a flow of an image storage process.

FIG. 6C is a flowchart illustrating an example of a flow of an image storage/display process.

FIG. 7A is a schematic diagram for describing image data processing according to the first embodiment of the present disclosure.

FIG. 7B is a schematic diagram for describing image data processing according to the first embodiment of the present disclosure.

FIG. 7C is a schematic diagram for describing image data processing according to the first embodiment of the present disclosure.

FIG. 8 is a flowchart illustrating an example of a flow of a process of an image reproduction program according to the first embodiment of the present disclosure.

FIG. 9 is a schematic diagram illustrating an example of a reproduction operation screen displayed on a display device.

FIG. 10A is a schematic diagram illustrating an example of a display mode of a reproduced image.

FIG. 10B is a schematic diagram illustrating an example of a display mode of a reproduced image.

FIG. 10C is a schematic diagram illustrating an example of a display mode of a reproduced image.

FIG. 11A is a flowchart illustrating an example of a flow of a process of an image display program according to a second embodiment of the present disclosure.

FIG. 11B is a flowchart illustrating an example of a flow of a wide range display process.

FIG. 12A is a schematic diagram illustrating an example of a display image according to a second embodiment of the present disclosure.

FIG. 12B is a schematic diagram illustrating an example of a display image according to the second embodiment of the present disclosure.

FIG. 12C is a schematic diagram illustrating an example of a display image according to the second embodiment of the present disclosure.

### DESCRIPTION OF EMBODIMENTS

Hereinafter, an exemplary embodiment of the present disclosure will be described in detail with reference to the drawings.

### First Embodiment

An image processing system of the present disclosure is an image processing system for a motorcycle, and displays a rear view image of an area behind an own vehicle to the rider. Here, the “motorcycles” means two-wheeled motorcycles, three-wheeled motorcycles, or four-wheeled motorcycles among saddle-style vehicles that a rider rides by straddling the vehicle. Examples of the motorcycle include one using an engine as a driving source and one using a motor as a driving source. Examples of the motorcycle include, for example, a motorcycle, a scooter, and an electrically powered scooter., Hereinafter, a case in which the motorcycle is a two-wheeled motorcycle will be described.

### Configuration of Video Processing System

First, a configuration of an image processing system will be described.

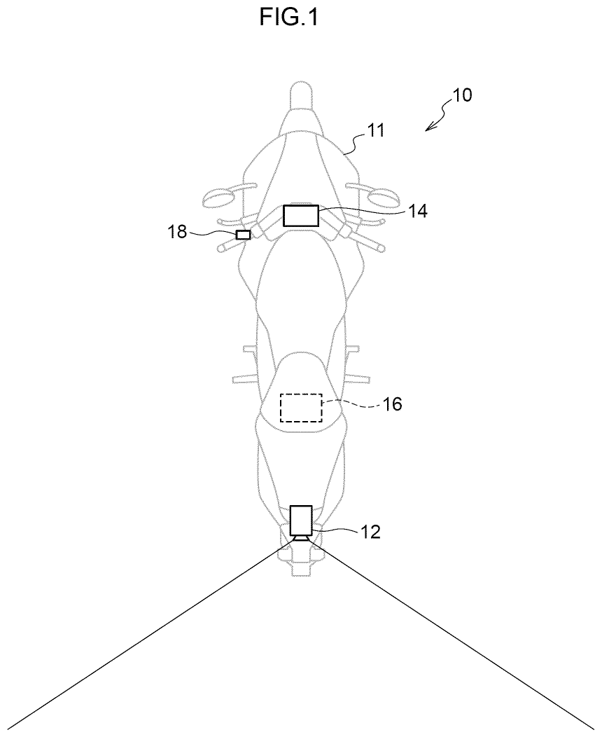

FIG. 1 is a schematic diagram illustrating an example of a configuration of an image processing system. As shown in FIG. 1, an image processing system 10 includes an imaging device 12, a display device 14, a control device 16, and an operation device 18. Although one device is shown as each of the above devices in FIG. 1, a plurality of imaging devices 12, a plurality of display devices 14, and a plurality of operation devices 18 may be provided.

The imaging device 12 is a device that images the surroundings of a vehicle body 11 of the motorcycle. As the imaging device 12, for example, a digital image camera including an image sensor such as a CCD image sensor or a CMOS image sensor may be used. The imaging device 12 may notify the following vehicle that recording is being performed by turning on a pilot lamp or the like during recording.

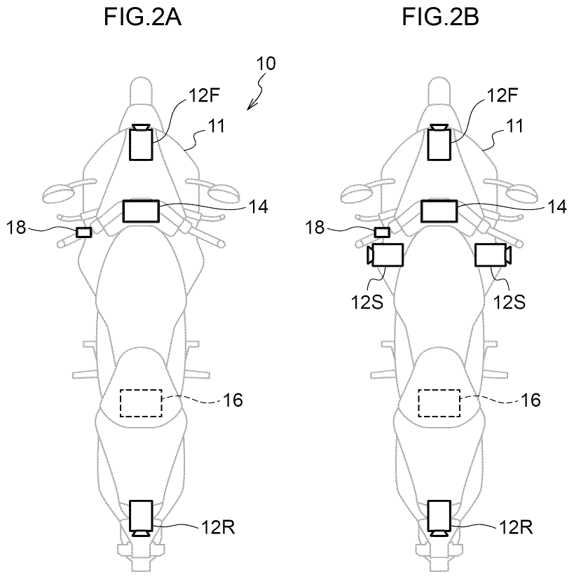

In a case in which one imaging device 12 is installed, as shown in FIG. 1, the imaging device 12 that images an area behind a vehicle is installed at a rear portion of the vehicle body 11. The imaging device 12 that images the area behind the vehicle is preferably disposed on the center line of the vehicle body 11. In a case in which a plurality of imaging devices 12 are installed, for example, as shown in FIG. 2A, an imaging device 12F that images an area in front of the vehicle may be installed at a front portion of the vehicle body 11 in addition to an imaging device 12R that images the area behind the vehicle, or as shown in FIG. 2B, imaging devices 12S that image side areas of the vehicle in addition to the areas behind and in front of the vehicle may be installed at side portions of the vehicle body 11. It is possible to cover all directions by disposing a plurality of imaging devices.

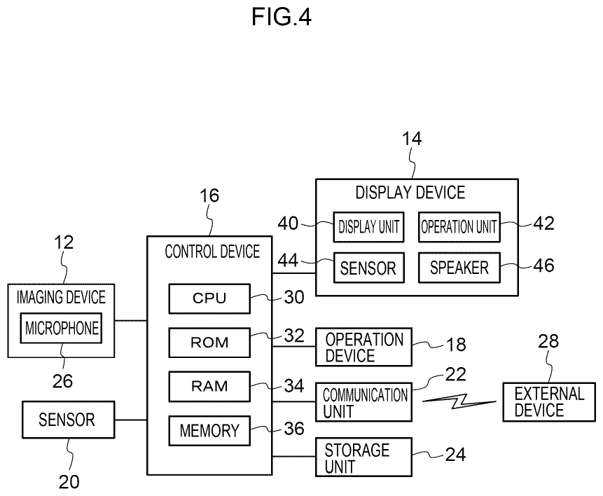

The display device 14 is a device that displays a rear view image of the area behind the vehicle to a rider. As a display unit 40 (see FIG. 4) of the display device 14, for example, a display such as a liquid crystal display, an organic EL display, or a touch panel display having a configuration in which a touch panel is overlaid such a display may be used. The display device 14 is installed at a position in front of the rider where the rider can easily see the display device.

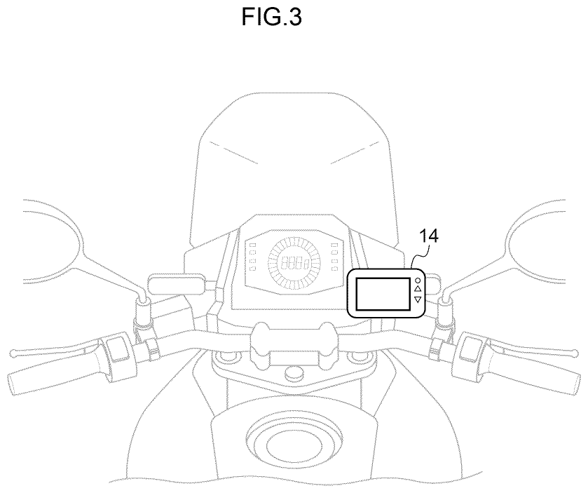

As the display device 14, a display provided on an instrument panel of the vehicle body 11 may be used, or a post-attached display may be used. For example, as shown in FIG. 3, in a case in which a meter display for displaying vehicle information is disposed at the center of the instrument panel, the display device 14 may be disposed near the meter display. In a case in which the display device 14 is disposed, a distance from the rider to instruments (for example, a meter display) and a distance from the rider to the display device 14 are made substantially the same, so that the rider can easily focus on the display device 14.

The control device 16 is a control function unit of an electronic control unit (that is, an ECU) provided to control the display device 14. The control device 16 is installed inside the vehicle body 11, for example, embedded inside the seat.

The operation device 18 is a device for the rider to perform operation input. As the operation device 18, a handle switch or the like attached near the handle may be used. According to the handle switch, the rider can perform operation input even while traveling. The operation device 18 can be attached to the left grip, for example.

### Electrical Configuration of Image Processing System

Next, an electrical configuration of image processing system 10 will be described.

FIG. 4 is a block diagram illustrating an example of an electrical configuration of the image processing system 10. The control device 16 includes a central processing unit (CPU) 30, a read only memory (ROM) 32, a random access memory (RAM) 34, and a nonvolatile memory 36. In the ROM 32 or the nonvolatile memory 36, a image display program and a image reproduction program that will be described later are stored in advance. The CPU 30 reads a program stored in advance, and executes the program by using the RAM 34 as a work area.

The imaging device 12, the display device 14, and the operation device 18 are connected to the control device 16 in a wired or wireless manner so as to be able to exchange data with the control device 16. The various sensors 20, the communication unit 22, and the storage unit 24 are also connected to the control device 16 in a wired or wireless manner so as to be able to exchange data with the control device 16. The control device 16 exchanges information with each unit and controls each unit.

The sensors 20 are an inclination sensor for detecting an inclination of the vehicle body 11, an acceleration sensor, and the like. The communication unit 22 is an interface for communicating with an external device 28. The storage unit 24 is an external storage device such as a hard disk drive (HDD) or a portable recording medium (for example, a memory card such as an SD card). The storage unit 24 stores image data and the like of various screens that will be described later. The control device 16 is installed inside the vehicle body 11 as an ECU together with the communication unit 22 and the storage unit 24. The control device 16, the communication unit 22, and the storage unit 24 may be housed in a common case. The portable recording medium is attachable to and detachable from the ECU.

The display device 14 includes a display unit 40, an operation unit 42, a sensor 44, a speaker 46, and the like. The display unit 40 is a display for displaying an image on the basis of the image data. The operation unit 42 is a switch or a button for performing an operation input. As described above, the display unit 40 may be a touch panel display, and in this case, the touch panel display also serves as the operation unit 42. The sensor 44 is an acceleration sensor for detecting an orientation of the display device 14. The speaker 46 is a device that outputs sound on the basis of audio data.

The configuration described above is an example, and other members may be added or some members may be omitted.

Here, an operation of the image processing system 10 will be briefly described.

A rear view image of the area behind the vehicle is captured by the imaging device 12, and the obtained image data is output to the control device 16. Control device 16 processes the obtained image data, and outputs the processed image data to display device 14. The display device 14 displays the image on the basis of the obtained image data.

The image processing system 10 also functions as a drive recorder that records image data obtained from the imaging device 12. Therefore, the control device 16 also performs processing of storing the image data in a storage device inside or outside the vehicle. In a case in which a plurality of imaging devices are provided, the control device 16 stores a plurality of pieces of image data obtained at the same time from the respective devices in the storage device in association with each other. Alternatively, the control device 16 may generate combined image data representing a combined image of a plurality of images, and store the combined image data in the storage device.

The image data may be stored in the storage unit 24, or may be transmitted to the outside via the communication unit 22 and stored in an external storage device. For example, the image data may be stored in a personal computer, a smartphone, or the like of a rider or another user. Hereinafter, a case in which the image data is stored in the storage unit 24 inside the vehicle body 11 will be described.

The rider can give various instructions via the operation device 18. For example, the image displayed on the display device 14 can be switched in response to an instruction from the rider input via the operation device 18. It is noted that the operation input from the rider may be performed via the operation unit 42 of the display device 14, or may be performed via an operation screen displayed on the display unit 40 of the display device 14.

The image processing system 10 may be configured to record data representing a situation around the vehicle in association with the image data. Examples of the data representing the situation around the vehicle include audio data and data of various sensors.

For example, the image processing system 10 may include a microphone 26 for collecting sound around the vehicle. The microphone 26 may be, for example, a microphone built in the imaging device 12 as shown in the drawing, or may be a post-attached microphone. The audio data obtained at the same time as the image data may be stored in the storage unit 24 in association with the image data.

The image processing system 10 may include a sensor such as a radar (for example, a millimeter-wave sensor) or a laser imaging detection and ranging (LiDAR) that detects a distance and a direction from an obstacle around the vehicle. Detection data obtained at the same time as the image data may be stored in the storage unit 24 in association with the image data.

### Functional Configuration of Control Device

Next, a functional configuration of the control device 16 will be described.

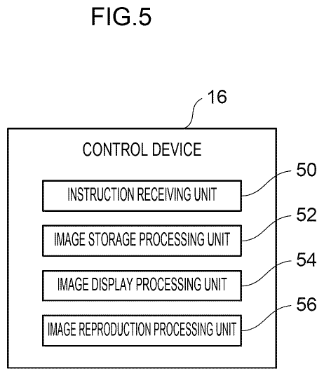

FIG. 5 is a functional block diagram illustrating an example of a functional configuration of the control device 16. The control device 16 includes an instruction receiving unit 50 that receives an instruction from a rider, an image storage processing unit 52 that stores image data in a storage device, an image display processing unit 54 that displays a rear view image on the display device 14, and an image reproduction processing unit 56 that reproduces the image data stored in the storage device. Each of these functional units is realized by the CPU 30 of the control device 16 executing a image storage/display program or a image reproduction program that will be described later.

### Image Storage/Display Program

Next, the image storage/display program will be described.

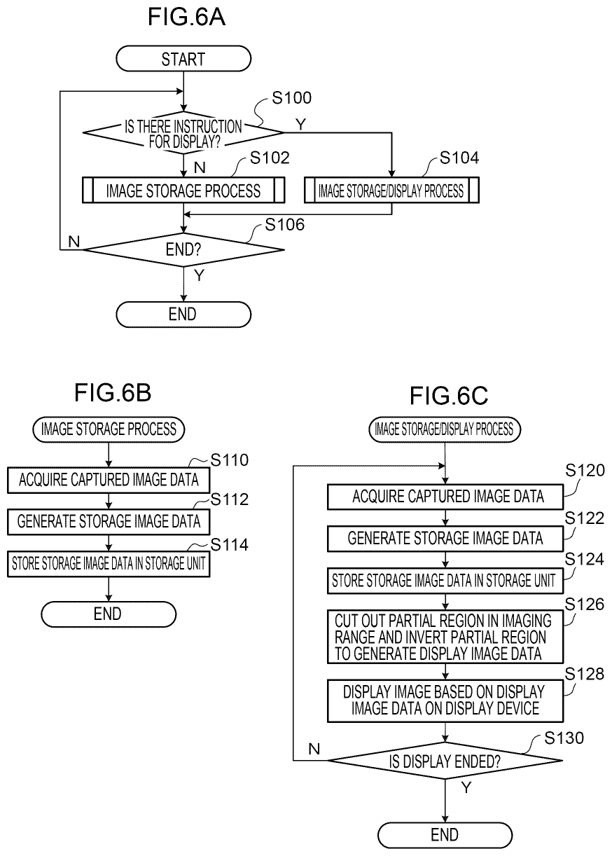

FIG. 6A is a flowchart illustrating an example of a flow of a process of the image storage/display program. The image storage/display program is executed by the CPU 30 of the control device 16, and is started in a case in which an engine is started through a switch operation of an engine start switch or the like. Here, a part of the operation of the CPU 30 will be described as an operation of each functional unit shown in FIG. 5.

First, in step S100, the instruction receiving unit 50 determines whether or not an instruction to display an image has been given. The instruction to display an image may be given by operating the operation device 18, for example. In a case in which the instruction to display an image is not given, the CPU 30 makes a NO determination in step S100, and the process proceeds to step S102. In step S102, the image storage processing unit 52 executes a image storage process.

On the other hand, in a case in which the instruction to display an image is given, the instruction receiving unit 50 makes a YES determination in step S100, and the process proceeds to step S104. In step S104, the image storage processing unit 52 and the image display processing unit 54 execute the image storage/display process.

That is, in the image processing system of the present embodiment, at the same time as the engine is started, the storage of the image data is started, and the storage of the image data is continuously performed until the engine is stopped. In a case in which the image processing system of the present embodiment is instructed to display an image from the rider, the image processing system stores image data and displays a rear view image on display device 14.

Next, in step S106, the CPU 30 determines whether or not to end the routine. For example, in a case in which an instruction to stop the engine is given through a switch operation of an engine start switch or the like, the CPU 30 makes a YES determination in step S106 and ends the routine. On the other hand, in a case in which the routine is not ended, the CPU 30 makes a NO determination in step S106, and the process returns to step S100. Therefore, the processes in steps S100 to S106 are repeatedly executed until the routine is ended.

### Image Storage Process

Next, a flow of the image storage process executed in step S102 will be described with reference to FIG. 6B.

First, in step S110, the image storage processing unit 52 acquires image data from the imaging device 12. Here, unprocessed image data obtained from the imaging device 12 will be referred to as captured image data. Next, in step S112, the image storage processing unit 52 performs image processing on the captured image data acquired from the imaging device 12 such that the captured image data is converted into a form suitable for storage, and generates image data for storage to be stored in the storage unit 24. Here, the image data for storage will be referred to as storage image data. In subsequent step S114, the image storage processing unit 52 stores the storage image data in the storage unit 24, and ends the routine.

### Image Storage/Display Process

Next, a flow of the image storage/display process executed in step S104 will be described with reference to FIG. 6C.

First, in step S120, the image storage processing unit 52 acquires the captured image data from the imaging device 12. Next, in step S122, the image storage processing unit 52 performs image processing on the captured image data acquired from the imaging device 12 such that the captured image data is converted into a form suitable for storage, and generates storage image data. In subsequent step S124, the image storage processing unit 52 stores the storage image data in the storage unit 24.

Next, in step S126, the image display processing unit 54 performs image processing on the captured image data so as to cut out a partial region of the imaging range as a display range and invert the image left and right in the display range to generates image data for display to be displayed on the display device 14. Here, the image data for display will be referred to as display image data. Next, in step S128, the display control unit 56 outputs the display image data to the display device 14, and causes the display device 14 to display an image based on the display image data.

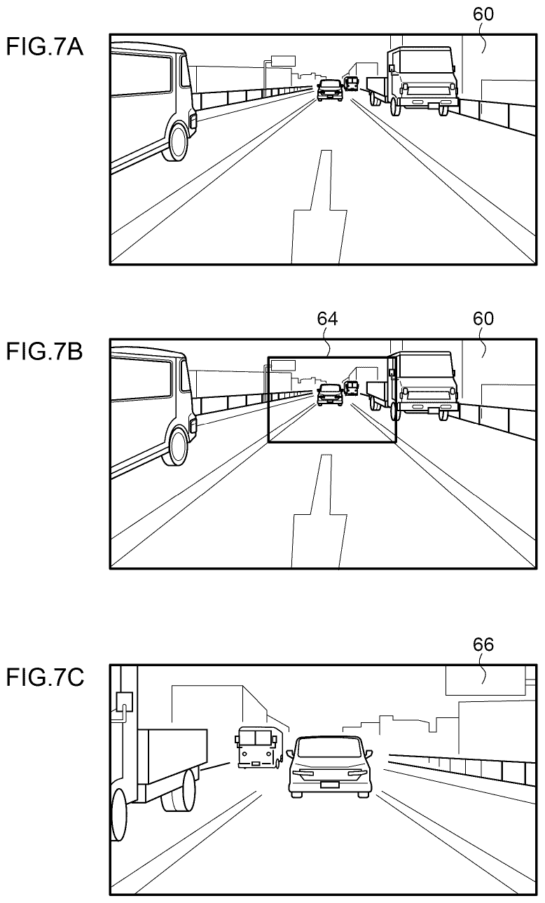

FIG. 7B is a diagram illustrating a state in which a partial region 64 is cut out from an imaging range of a captured image 60 shown in FIG. 7A. The imaging device 12 images a wide range area behind the vehicle, but the rider wants to see a blind spot area immediately behind the rider. On the other hand, the captured image is captured such that the blind spot area is located at the center of the imaging range. Therefore, the region 64 including the central portion of the imaging range is cut out as a display range. By cutting out and displaying a partial region 64, a range that the rider wants to see can be displayed large.

FIG. 7C is a diagram illustrating a display image 66 based on the display image data. The display image 66 is an inverted image of the image corresponding to region 64. In a case in which the image displayed on the display device 14 has the same left-right orientation as a mirror image reflected in the rearview mirror, the rider can easily grasp the situation behind the own vehicle.

Here, the description returns to FIG. 6C. Next, in step S130, the image display processing unit 54 determines whether or not to end the image display. For example, in a case in which an instruction to end the image display is given by operating the operation device 18, the image display processing unit 54 makes a YES determination in step S130 and ends the routine. For example, in a case in which the instruction to end the image display is given from the rider during traveling, the image display processing unit 54 ends the image display, and the routine is also ended. On the other hand, in a case in which the image display is not ended, the image display processing unit 54 makes a NO determination in step S130, and the process returns to step S120. Therefore, the processes in steps S120 to S130 are repeatedly executed until the instruction to end the image display is given.

In a case in which the image storage processing unit 52 generates storage image data or in a case in which the image display processing unit 54 generates display image data, various types of image processing such as rotation correction, distortion correction, color correction, and noise removal may be performed.

For example, the image processing at the time of generating the storage image data includes a process of removing an unnecessary portion from the captured image data. In the case of the imaging device 12 including a wide-angle lens, distortion may occur in the peripheral portion of the image. In such a case, it is preferable that the image storage processing unit 52 performs image processing on the captured image data so that the peripheral portion of the image is removed. By deleting a part of the image data before the image data is stored in the storage unit 24, the amount of data to be stored can be reduced.

The image storage processing unit 52 may also perform other image processing on the captured image data. For example, the image storage processing unit 52 may perform a process of rotationally correcting the captured image data according to an inclination of the vehicle body 11 detected by the sensor 20. In addition, the image storage processing unit 52 may perform a process of inverting the image left and right and store image data of the inverted image.

Step S112 in FIG. 6B and step S122 in FIG. 6C may be skipped, and the captured image data may be used as the storage image data without any processing. Since the captured image data includes a larger amount of visual information, a larger amount of information may be provided to a user in the future than in a case in which a part of the image is cut out.

In step S126 in FIG. 6C, an example in which the image display processing unit 54 performs image processing on the captured image data to generate the display image data has been described, but the image display processing unit 54 may generate the display image data from the storage image data subjected to the image processing in step S122 in FIG. 6C.

### Image Reproduction Program

As described above, while the vehicle is traveling, an image obtained by cutting out a partial region of the captured image is displayed to the rider. In the first embodiment, the rider and other viewers can also reproduce the storage image data, that is, image data in a wide range while the vehicle is stopped.

Next, an image reproduction program will be described.

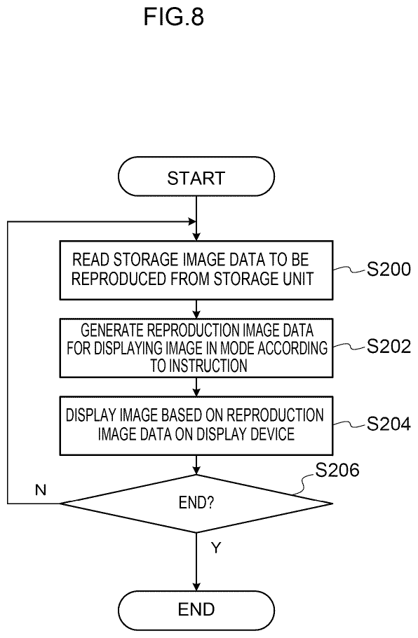

FIG. 8 is a flowchart illustrating an example of a flow of a process of the image reproduction program. This image reproduction program is executed by the CPU 30 of the control device 16, and is started in a case in which an instruction to reproduce an image is given. Here, the operation of the CPU 30 will be described as the operation of the reproduction control unit 58 shown in FIG. 5.

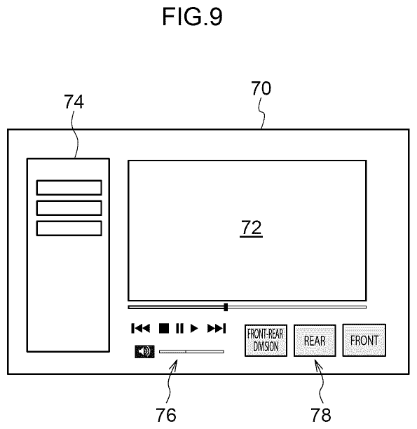

The instruction to reproduce an image may be given by operating a reproduction operation screen shown in FIG. 9 displayed on the display unit 40 of the display device 14, for example. A reproduction operation screen 70 includes an image display unit 72 that displays a reproduced image, a selection unit 74 that selects storage image data to be reproduced, various instruction buttons 76, a display mode selection button 78, and the like.

For example, in a case in which image data of a rear view image and a front view image is recorded, it is possible to select, as the display mode, display of only the rear view image, display of only the front view image, and divided display of the rear view image and the front view image. In a case in which a viewer selects the storage image data to be reproduced and a display mode through a screen operation and gives an instruction for reproduction, reproduction is started.

First, in step S200, the reproduction control unit 58 reads storage image data to be reproduced from the storage unit 24. Next, in step S202, the reproduction control unit 58 generates image data for displaying an image in a mode according to the instruction. Here, the image data for reproduction display will be referred to as reproduction image data. Next, in step S204, the reproduction control unit 58 outputs the reproduction image data to the display device 14, and causes the display device 14 to display an image based on the reproduction image data.

As described above, the storage image includes a wider imaging range unlike the display image obtained by cutting out a part of the imaging range of the captured image. The storage image data is used, for example, for verification of a situation in which an accident has occurred. Therefore, an image in a wide range including a larger amount of visual information can be reproduced.

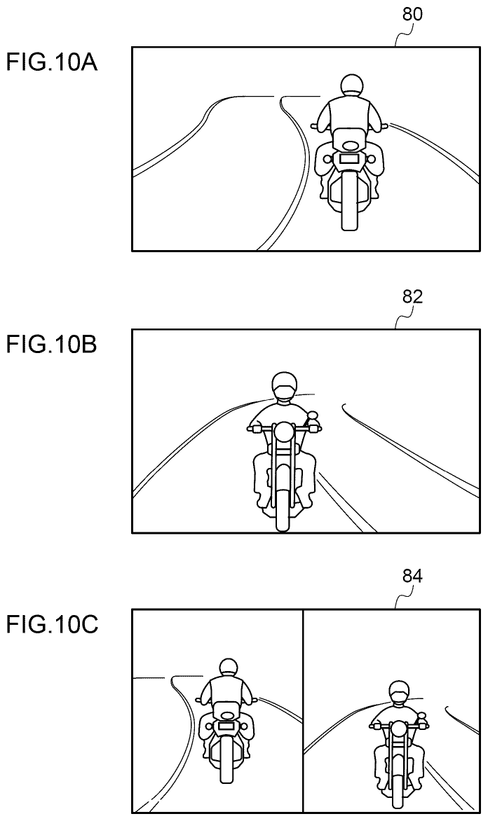

It is preferable that the storage image data can be reproduced in a plurality of display modes so that a user can verify a situation around the vehicle from different angles. In the display mode of only the front view image, only a front view image 80 is displayed as shown in FIG. 10A. In the display mode of only the rear view image, only a rear view image 82 is displayed as shown in FIG. 10B. In the display mode of the divided display, as shown in FIG. 10C, a combined image 84 of the rear view image and the front view image is displayed. The image data of the rear view image and the image data of the front view image are combined, and the combined image 84 is displayed on the basis of the obtained combined image data.

It is noted that the “storage image data” is an example of “first image data of a first image” of the present disclosure, and the “display image based on display image data” is an example of a “second image” of the present disclosure.

As described above, according to the image processing system according to the first embodiment, various effects as described below can be obtained.
(1) Although the imaging device images a wide range of the area behind an own vehicle, an image obtained by cutting out a region that the rider wants to see in the imaging range is displayed on the display device disposed in front of the rider while the rider is traveling. Therefore, the range that the rider wants to see is displayed large, thus improving visibility. The rider can check an area that is a blind spot right behind the rider, and the rear checking is facilitated. Since the rear checking is facilitated, rearward-glancing action by the rider can be reduced, and improvement in safety is expected.
(2) Since the image processing system stores the image data in a wide range captured by the imaging device during traveling in a reproducible manner, it is possible to store the image data suitable for the post-checking. In a case in which an accident occurs, these pieces of image data can also be used as evidence for proving the accident occurrence situation.

The control device for display control (that is, the ECU) is made multifunctional, and the control device for display control performs control to store the captured image data in the storage device, so that the image processing system can store the captured image data in a wide range without adding a new ECU.

By recording image data from a plurality of imaging devices in association with each other or recording audio data or detection data from various sensors in association with image data, a larger amount of information can be obtained from the stored data.
(3) Since the control device in which a portable recording medium such as an SD card is inserted as the storage unit is installed inside the vehicle body, unlike a commercially available post-attached drive recorder, the recording medium cannot be easily taken out, and the recording medium storing the image data is prevented from being stolen.
(4) By notifying the following vehicle that recording is being performed by turning on a pilot lamp of the imaging device or the like, it is possible to suppress dangerous behavior such as tailgating.

### Second Embodiment

In the first embodiment, the image processing system 10 is configured to reproduce the storage image data so that an image in a wide range can be checked while the vehicle is stopped. In the second embodiment, however, the image processing system 10 is configured to switch the image during traveling so that an image covering a range different from that of the original image can be displayed. Here, an example in which the image processing system 10 switches the original image to an image covering a wider range (for example, a storage image) according to a switching instruction from the rider will be described.

The second embodiment is different from the first embodiment in a flow of the image storage/display process of the image storage/display program shown in FIG. 6A. Therefore, description of the same portions as those of the first embodiment will be omitted, and only differences will be described.

### Video Storage/Display Process

Next, a image storage/display process of the second embodiment will be described.

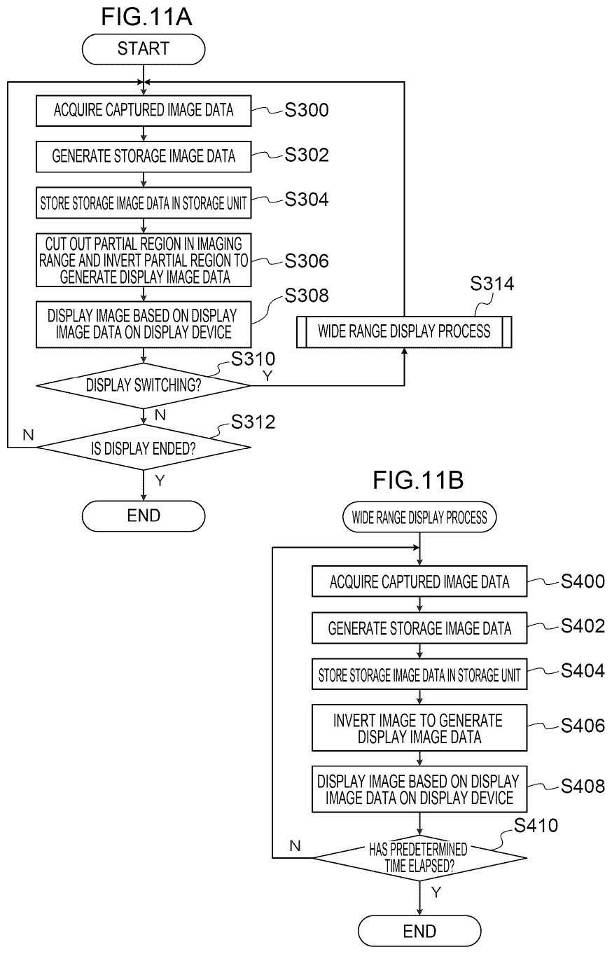

FIGS. 11A and 11B are flowcharts illustrating an example of a flow of a image storage/display process. Here, the operation of the CPU 30 will be described as the operation of each functional unit shown in FIG. 5.

First, in step S300 in FIG. 11A, the image storage processing unit 52 acquires captured image data from the imaging device 12. Next, in step S302, the image storage processing unit 52 performs image processing on the captured image data such that the captured image data is converted into a form suitable for storage, and generates storage image data to be stored in the storage unit 24. In subsequent step S304, the image storage processing unit 52 stores the storage image data in the storage unit 24. Step S302 may be skipped.

Next, in step S306, the image display processing unit 54 performs image processing on the captured image data so as to cut out a partial region of the imaging range as a display range and invert the image left and right in the display range to generate display image data to be displayed on the display device 14. In subsequent step S308, the image display processing unit 54 outputs the display image data to the display device 14, and causes the display device 14 to display an image based on the display image data.

The processes in steps S300 to S308 correspond to the processes in steps S100 to S108 shown in FIG. 7, and thus, refer to the description of FIG. 7 for details of each step.

Next, in step S310, the instruction receiving unit 50 determines whether or not an instruction to switch to an image in a wide range has been given. For example, in a case in which an instruction to switch an image has been given through the rider's operation on the operation device 18, the instruction receiving unit 50 makes a YES determination in step S310, and the process proceeds to step S314. In a case in which the instruction to switch an image has not been given, the instruction receiving unit 50 makes a NO determination in step S310, and the process proceeds to step S312.

In a case in which the instruction to switch an image has been given, next, in step S314, the image storage processing unit 52 and the image display processing unit 54 execute a wide range display process for switching the display image to an image in a wide range. Here, a subroutine of the wide range display process will be described with reference to FIG. 11B.

The image storage processing unit 52 acquires captured image data from the imaging device 12 in step S400, performs image processing on the captured image data such that the captured image data is converted into a form suitable for storage in step S402, generates storage image data to be stored in the storage unit 24, and stores the storage image data in the storage unit 24 in subsequent step S404. Step S402 may be skipped.

Next, in step S406, the image display processing unit 54 performs image processing on the captured image data or the storage image data such that an image is inverted left and right, and generates display image data to be displayed on the display device 14. That is, in the second embodiment, image processing of cutting out a part of the imaging range is not performed. In subsequent step S408, the image display processing unit 54 outputs the display image data to the display device 14, and causes the display device 14 to display an image based on the display image data.

Next, in step S410, the image display processing unit 54 determines whether or not a predetermined time has elapsed. The predetermined time is, for example, 1 to 10 seconds. In a case in which the predetermined time has elapsed, the image display processing unit 54 makes a YES determination in step S410 and ends the routine, and in a case in which the predetermined time has not elapsed, the image display processing unit 54 makes a NO determination in step S410 and the process returns to step S400. Therefore, the processes in steps S400 to S410 are repeatedly executed until the predetermined time elapses. In a case in which the wide range display process is ended, the process returns to step S300 in FIG. 11A.

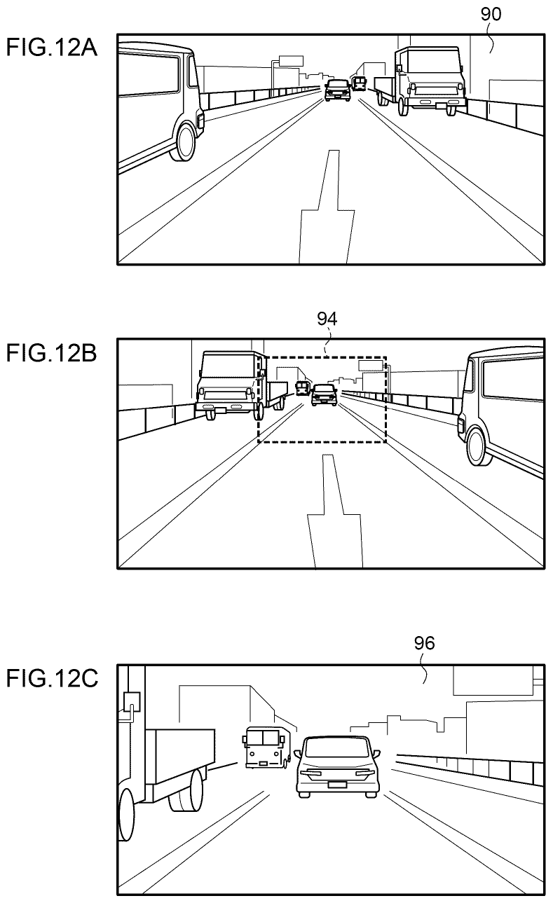

FIG. 12A shows a captured image 90. FIG. 12B shows a display image 92 covering a wide range. The display image 92 is an inverted image obtained by inverting left and right the entire imaging range of the captured image 90. A region 94 surrounded by a dotted frame is a narrow range cut out as the display range in step S306 in FIG. 11A. FIG. 12C shows a display image 96 in a narrow range.

In a case in which an instruction to switch an image has been given through an operation on the operation device 18, the image displayed on the display device 14 is switched from the display image 96 in a narrow range to the display image 92 in a wide range. In a case in which a predetermined time elapses after switching to the display image 92 in a wide range, the display image returns to the display image 96 in a narrow range. Alternatively, the image display processing unit 54 may switch the display image 92 in a wide range to the display image 96 in a narrow range in response to a switching operation of the rider.

Here, the description returns to FIG. 11A. In a case in which the instruction to switch an image has not been given, next, in step S312, the image display processing unit 54 determines whether or not to end the image display. For example, in a case in which an instruction to end the image display is given by operating the operation device 18, the image display processing unit 54 makes a YES determination in step S312 and ends the routine. On the other hand, in a case in which the image display is not ended, the process returns to step S300. Therefore, the processes in steps S300 to S314 are repeatedly executed until the instruction to end the image display is given.

As described above, in the image processing system according to the second embodiment, the same effects as those of the first embodiment can be obtained, and in addition, an image covering a wide range can be checked even during traveling of a motorcycle.

### MODIFICATION EXAMPLES

The configuration of the image processing system described in each of the above embodiments is an example, and it goes without saying that the configuration may be changed within the scope without departing from the concept of the present disclosure.

In the above embodiment, the image processing system displays the image in response to an instruction from the rider, but the image processing system may display the image according to detection results from various sensors included in the vehicle. Examples of the various sensors include a blind spot monitor (BSM) that detects approach of a vehicle from behind an own vehicle, a sensor that detects an inclination of a vehicle, and a vehicle speed sensor. For example, the image processing system may display an image in response to an alarm from the BSM.

In the above embodiments, an example has been described in which storage of the image data is started simultaneously with the engine start, the storage of the image data is continuously performed until the engine is stopped, and the image is displayed in response to an instruction from the rider, that is, only in a case in which the rider wants to see the image. However, a timing of storing the image data and a timing of displaying the image are not limited to this example. The timing of displaying the image may be the same as or different from the timing of storing the image data, but it is desirable that the timings are different from each other as described in the above embodiment. It is desirable that the image data is always stored during the traveling of the motorcycle, but a timing of starting the storage of the image data is not limited to a time of starting the engine. For example, the image processing system may start the storage of the image data in response to an instruction from the rider.

In the above embodiments, an example in which the display device is installed on the right side or the left side (as viewed from the rider) of the meter display of the instrument panel has been described, but the display device may be installed at a position in front of the rider where the rider can easily see the display device regardless of the presence or absence of the meter display. For example, the display device may be installed on a handle, on an attachment portion of a mirror, on an upper portion of a fuel tank, in a cowl, or on an upper side of a meter display.

In the above embodiments, an example in which a dedicated display device is provided in the image processing system has been described, but a portable information processing device such as a smartphone or a tablet terminal may be used as the display device. In this case, the portable information processing device executes various processes in cooperation with the ECU that is the control device, by using an installed dedicated application program. For example, the smartphone is wirelessly connected to the communication unit 22 by Bluetooth (registered trademark), and can display an image based on the image data stored in the storage unit 24 on a screen of the smartphone (see FIG. 4).

The present application claims priority from Japanese Patent Application No. 2022-207657 filed on Dec. 23, 2022, the entire disclosure of which is incorporated herein by reference.

1. An image processing system comprising:
an imaging device that images an area behind a motorcycle;
a display device that is disposed to be located in front of a rider and displays an image based on image data acquired from the imaging device; and
a control device that is configured to perform:
first control of storing, in a storage device, first image data of a first image corresponding to a first region in an imaging range of a captured image captured by the imaging device during traveling of the motorcycle, and
second control of displaying, on the display device, a second image corresponding to a second region that is narrower than the first region in the imaging range.

2. The image processing system according to claim 1, wherein the control device is configured to perform the second control of displaying the second image on the display device at a timing that is different from a timing of the first control of storing the first image data in the storage device.

3. The image processing system according to claim 1, further comprising at least one second imaging device that images an area in front of or on a side of the motorcycle, wherein, in the first control, the control device is configured to store, in the storage device, second image data acquired from the at least one second imaging device at a time when the first image is acquired, in association with the first image data.

4. The image processing system according to claim 3, wherein the control device is configured to further perform third control of reproducing the first image data stored in the storage device and displaying an image on the display device, and the third control includes displaying an image that is different from the first image on the display device based on combined image data obtained by combining the first image data and the second image data stored in the storage device.

5. The image processing system according to claim 1, wherein the control device is configured to perform a fourth control that causes the display device to display an image of a range that is different from that of the second image in response to an image switching instruction received from the rider during display of the second image.

6. The image processing system according to claim 1, wherein at least one of the first image data or image data of the second image is subjected to predetermined image processing including rotation correction.

7. The image processing system according to claim 1, further comprising a microphone that collects sound, wherein, in the first control, the control device is configured to store, in the storage device, audio data acquired from the microphone at a time when the first image is acquired, in association with the first image data.

8. The image processing system according to claim 1, further comprising a sensor that detects a distance and a direction from an obstacle around the motorcycle, wherein, in the first control, the control device is configured to store, in the storage device, detection data acquired from the sensor at a time when the first image is acquired, in association with the first image data.

9. The image processing system according to claim 1, wherein the storage device is disposed inside a vehicle body of the motorcycle together with the control device.

10. The image processing system according to claim 1, wherein the storage device is a portable recording medium.

11. The image processing system according to claim 1, wherein the storage device is disposed outside a vehicle body of the motorcycle, and the control device is configured to transmit the first image data to the external storage device and cause the external storage device to store the first image data.

12. The image processing system according to claim 1, wherein the first image data is image data that is acquired from the imaging device and is not subjected to any processing.
